(19) United States
(12) Patent Application Publication
(10) Pub. No.: US 2017/0187069 A1
(43) Pub. Date: Jun. 29, 2017

(54) ELECTROLYTE SOLUTION COMPRISING SULFUR DIOXIDE-BASED IONIC LIQUID ELECTROLYTE, AND SODIUM-SULFUR DIOXIDE SECONDARY BATTERY HAVING SAME

(71) Applicant: KOREA ELECTRONICS TECHNOLOGY INSTITUTE, Seongnam-si, Gyeonggi-do (KR)

(72) Inventors: Taeeun YIM, Seoul (KR); Youngjun KIM, Seongnam-si, Gyeonggi-do (KR); Youngkwon KIM, Seongnam-si, Gyeonggi-do (KR); Minsik PARK, Suwon-si, Gyeonggi-do (KR); Goojin JEONG, GSeongnam-si, yeonggi-do (KR); Yongnam JO, Yongin-si, Gyeonggi-do (KR)

(21) Appl. No.: 15/316,149

(22) PCT Filed: Aug. 25, 2015
(86) PCT No.: PCT/KR2015/008854

§ 371 Date: Dec. 2, 2016

(30) Foreign Application Priority Data
Sep. 16, 2014 (KR) 10-2014-0122850

(51) Int. Cl. H01M 10/0568; H01M 10/0569; H01M 4/38; H01M 10/054; H01M 4/587

(52) U.S. Cl. CPC H01M 10/0568; H01M 10/054; H01M 4/587; H01M 4/381; H01M 10/0569; H01M 2300/0045

(57) ABSTRACT

The described technology relates to an electrolyte solution comprising a sulfur dioxide-based ionic liquid electrolyte, and a sodium-sulfur dioxide (Na—SO₂) secondary battery having same, one purpose of the described technology being to enhance the storage characteristics of sulfur dioxide gas in an electrolyte solution. The sodium-sulfur dioxide secondary battery includes a negative electrode which is formed from an inorganic material and which contains sodium. The battery also includes a positive electrode which is formed from a carbon material and a sulfur dioxide-based inorganic electrolyte solution. Here, the electrolyte solution contains a sulfur dioxide-based ionic liquid electrolyte prepared by injecting SO₂ gas in an ionic liquid.

### TECHNICAL FIELD

The present invention relates to a sodium-based secondary battery, and more specifically, to an electrolyte solution including a sulfur dioxide-based ionic liquid electrolyte that can improve the storage characteristic of sulfur dioxide gas in a sulfur dioxide (SO₂)-based electrolyte solution, and a sodium-sulfur dioxide (Na—SO₂) secondary battery having the same.

### BACKGROUND ART

As the needs of consumers have changed due to digitalization and high performance of electronic products, and the like, market demand is being changed to the development of batteries that are thin, lightweight, and have a high capacity according to a high energy density. Also, in order to address future energy and environment problems, the development of hybrid electric vehicles, electric vehicles, and fuel cell vehicles is actively progressing, and there is a demand for a large-sized battery for vehicle power.

Lithium-based secondary batteries have been put to practical use as batteries that can be reduced in size and weight and can be charged and discharged in a high capacity, and have been used in portable electronic devices and communication devices such as small video cameras, mobile phones, notebook PCs, and the like. A lithium-based secondary battery is composed of a positive electrode, a negative electrode, and an electrolyte. Since lithium ions released from a positive electrode active material by charging serve to transfer energy by being inserted into a negative electrode active material and being desorbed again when discharging is performed, i.e., by shuttling between both electrodes, a lithium-based secondary battery can be charged and discharged.

Meanwhile, research on a sodium-based secondary battery using sodium instead of lithium has recently been in focus again. Since sodium is an abundant resource, when a secondary battery using sodium instead of lithium is manufactured, it is possible to manufacture the secondary battery at a low cost. As such, a sodium-based secondary battery is useful, but a conventional sodium metal-based secondary battery, for example, NAS (Na—S battery) and ZEBRA (Na—NiCl₂ battery), is unable to be used at room temperature. That is, there are problems such as battery safety due to the use of liquid-phase sodium and a positive electrode active material at high temperature and battery performance deterioration due to corrosion. Recently, research on a sodium ion battery using deintercalation of sodium ions has been actively progressing, but their energy density and lifetime characteristics are still poor. Therefore, there is a demand for a sodium-based secondary battery that can be used at room temperature and has excellent energy density and lifetime characteristics.

In order to address these problems, a sodium-sulfur dioxide (Na—SO₂) secondary battery has been introduced. A sodium-sulfur dioxide secondary battery is a new battery system that can significantly improve a low energy density of a conventional lithium-based secondary battery by using, as an electrolyte, a material present in a molten salt form at room temperature and can be used as an electric power source for large-capacity power storage using the electrolyte.

In particular, a sodium-sulfur dioxide secondary battery is a new battery system with an advantage of lowering a cost to less than half of an existing lithium-based secondary battery by using low-cost sodium (Na). For example, as an electrolyte of a sodium-sulfur dioxide secondary battery, NaAlCl₄-xSO₂ prepared by injecting sulfur dioxide gas into NaAlCl₄ is mainly used.

However, since sulfur dioxide is present in a gaseous state in an electrolyte, the NaAlCl₄-xSO₂ electrolyte has a potential problem in which sulfur dioxide is volatilized over time. Accordingly, when a content of sulfur dioxide in the NaAlCl₄-xSO₂ electrolyte decreases due to volatilization of sulfur dioxide, performance of a sodium-sulfur dioxide secondary battery may be degraded.

### PRIOR-ART DOCUMENT

### Patent Document

Korean Patent No. 10-1254613 (Apr. 9, 2013)

### DISCLOSURE

### Technical Problem

It is an object of the present invention to provide an electrolyte solution including a sulfur dioxide-based ionic liquid electrolyte that can improve the storage characteristic of sulfur dioxide gas in a sulfur dioxide-based electrolyte solution, and a sodium-sulfur dioxide (Na—SO₂) secondary battery having the same.

### Technical Solution

In order to accomplish the above object, the present invention provides a sodium-sulfur dioxide secondary battery which includes a negative electrode made of an inorganic material containing sodium, a positive electrode made of a carbon material, and an electrolyte solution containing a sulfur dioxide-based ionic liquid electrolyte prepared by injecting sulfur dioxide (SO₂) gas into an ionic liquid.

In the sodium-sulfur dioxide secondary battery according to the present invention, in the electrolyte solution, the sulfur dioxide (SO₂) gas may be injected into the ionic liquid to a saturated state.

In the sodium-sulfur dioxide secondary battery according to the present invention, the ionic liquid may be ethyl methyl imidazolium tetrachloroaluminate (EMIm-AlCl₄) or propyl methyl pyrrolidinium tetrachloroaluminate (PMPyrr-AlCl₄).

In the sodium-sulfur dioxide secondary battery according to the present invention, the ionic liquid electrolyte may be EMIM-AlCl₄-xSO₂ or PMPyrr-AlCl₄-xSO₂ (1.5≦x≦3.0).

In the sodium-sulfur dioxide secondary battery according to the present invention, the electrolyte solution may further include a sulfur dioxide-based inorganic electrolyte.

In the sodium-sulfur dioxide secondary battery according to the present invention, the sulfur dioxide-based inorganic electrolyte may be NaAlCl₄-xSO₂ (1.5≦x≦3.0).

The present invention also provides a sodium-sulfur dioxide secondary battery including an electrolyte solution containing a sulfur dioxide-based ionic liquid electrolyte prepared by injecting sulfur dioxide (SO₂) gas into an ionic liquid.

The present invention also provides an electrolyte solution for a sodium-sulfur dioxide secondary battery including an electrolyte solution containing a sulfur dioxide-based ionic liquid electrolyte prepared by injecting sulfur dioxide (SO₂) gas into an ionic liquid.

In the electrolyte solution for a sodium-sulfur dioxide secondary battery according to the present invention, the sulfur dioxide (SO₂) gas may be injected into the ionic liquid to a saturated state.

### Advantageous Effects

According to the present invention, a sulfur dioxide-based ionic liquid electrolyte is used alone or as an additive in an electrolyte solution for a sodium-sulfur dioxide secondary battery, and therefore volatility of the sulfur dioxide gas included in a sulfur dioxide-based electrolyte solution can be controlled to improve the storage characteristic of the sulfur dioxide gas in the electrolyte solution. That is, since the ionic liquid electrolyte has physical properties such as non-volatility, an ionic liquid included in the electrolyte solution suppresses volatility of the sulfur dioxide gas present in the electrolyte solution, and as a result, the sulfur dioxide gas can be present in a stable state in the electrolyte solution.

### DESCRIPTION OF DRAWINGS

FIG. 1 is a diagram for describing a sodium-sulfur dioxide secondary battery according to the present invention.

FIG. 2 is a graph illustrating the evaluation of a SO₂ solubility characteristic of sodium-sulfur dioxide secondary batteries according to embodiments of the present invention.

FIG. 3 is a graph illustrating the evaluation of a change in a sulfur dioxide (SO₂) concentration based on storage time of sodium-sulfur dioxide secondary batteries according to embodiments of the present invention and a comparative example.

FIG. 4 is a graph illustrating the evaluation of a SO₂ storage characteristic of sodium-sulfur dioxide secondary batteries according to embodiments of the present invention and a comparative example.

### MODES OF THE INVENTION

It should be noted that the following detailed descriptions merely provide parts necessary to understand embodiments of the present invention and the other descriptions of the present invention are omitted within a range within which the gist of the present invention is not obscured.

Terms or words used herein shall not be limited to common or dictionary meanings, and have meanings corresponding to technical aspects of the embodiments of the present invention so as to most suitably describe the embodiments of the present invention. Accordingly, the configurations shown in the drawings and embodiments disclosed in the present specification are merely preferred embodiments of the present invention and do not represent the full technical spirit of the present invention. Therefore, it should be understood that various equivalents and modifications may be present at a filing time of the present application.

Hereinafter, embodiments of the present invention will be described in more detail with reference to the accompanying drawings.

FIG. 1 is a diagram to describe a sodium-sulfur dioxide secondary battery according to the present invention.

Referring to FIG. 1, a sodium-sulfur dioxide secondary battery 100 according to the present invention includes a positive electrode 2 made of a carbon material, a negative electrode 3 containing sodium, and a sulfur dioxide-based electrolyte solution 1, and may further include a case 4. Here, the sulfur dioxide-based electrolyte solution 1 includes a sulfur dioxide-based ionic liquid electrolyte.

Here, the positive electrode 2 is composed of a porous carbon material. This positive electrode 2 provides a place where an oxidation-reduction reaction of a sulfur dioxide-based electrolyte occurs. In some cases, the carbon material constituting the positive electrode 2 may include one or two or more hetero-elements. The hetero element refers to nitrogen (N), oxygen (O), boron (B), fluorine (F), phosphorus (P), sulfur (S), or silicon (Si). A content of the hetero element is 0 to 20 at %, and preferably 5 to 15 at %. When a content of the hetero element is less than 5 at %, there is only a slight increase in a capacity as a result of the addition of the hetero element, and when a content of the hetero element is 15 at % or more, electrical conductivity and ease of electrode molding of the carbon material decrease.

Also, the positive electrode 2 may further include a metal chloride, a metal fluoride, or a metal bromide in addition to a porous carbon material.

Here, the metal chloride may include one or two or more of CuCl₂, CuCl, NiCl₂, FeCl₂, FeCl₃, COCl₂, MnCl₂, CrCl₂, CrCl₃, VCl₂, VCl₃, ZnCl₂, ZrCl₄, NbCl₅, MoCl₃, MoCl₅, RuCl₃, RhCl₃, PdCl₂, AgCl, and CdCl₂. For example, the positive electrode 2 may include a porous carbon material and CuCl₂ in a predetermined weight ratio. When CuCl₂ is charged and discharged, a Cu oxidation number is changed and reaction with sodium ions occurs, and as a result, discharging products such as Cu and NaCl are obtained. Also, when charging is performed, CuCl₂ is reversibly re-formed. A content of the metal chloride in the positive electrode 2 may be 50 to 100 wt % or 60 to 99 wt %, and preferably 70 to 95 wt % for mixing with additional elements for improvement of characteristics of the positive electrode 2.

A metal fluoride may include one or two or more of CuF₂, CuF, NiF₂, FeF₂, FeF₃, CoF₂, CoF₃, MnF₂, CrF₂, CrF₃, ZnF₂, ZrF₄, ZrF₂, TiF₄, TiF₃, AgF₂, SbF₃, GaF₃, and NbF₅. For example, the positive electrode 2 may include a porous carbon material and CuF₂ in a predetermined weight ratio. When CuF₂ is charged and discharged, a Cu oxidation number is changed and reaction with sodium ions occurs, and as a result, discharging products such as Cu and NaCl are obtained. Also, when charging is performed, CuF₂ is reversibly re-formed. A content of the metal fluoride in the positive electrode 2 may be 50 to 100 wt % or 60 to 99 wt %, and preferably 70 to 95 wt % for mixing with additional elements for improvement of characteristics of the positive electrode 2.

A metal bromide may include one or two or more of CuBr₂, CuBr, NiBr₂, FeBr₂, FeBr₃, CoBr₂, MnBr₂, CrBr₂, ZnBr₂, ZrBr₄, ZrBr₂, TiBr₄, TiBr₃, NbBr₅, AgBr, SbBr₃, GaBr₃, BiBr₃, MoBr₃, SnBr₂, WBr₆, and WBr₅. For example, the positive electrode 2 may include a porous carbon material and CuBr₂ in a predetermined weight ratio. When CuBr₂ is charged and discharged, a Cu oxidation number is changed and reaction with sodium ions occurs, and as a result, discharging products such as Cu and NaCl are obtained. Also, when charging is performed, CuBr₂ is reversibly re-formed. A content of the metal bromide in the positive electrode 2 may be 50 to 100 wt % or 60 to 99 wt %, and preferably 70 to 95 wt % for mixing with additional elements for improvement of characteristics of the positive electrode 2.

As the negative electrode 3, a sodium metal, an alloy including sodium, an intermetallic compound containing sodium, a carbon material containing sodium, an inorganic material containing sodium, and the like may be used. The inorganic material may include at least one of an oxide, a sulfide, a phosphide, a nitride, and a fluoride. A content of a negative electrode material in the negative electrode 3 may be 60 to 100 wt %.

The sulfur dioxide-based electrolyte solution 1 used as an electrolyte and a positive electrode active material includes a sulfur dioxide-based ionic liquid electrolyte that can stably capture sulfur dioxide gas in an electrolyte solution. An ionic liquid electrolyte of ionic liquid-xSO₂ has a molar ratio (x) of a SO₂ content of 0.5 to 10, preferably, 1.5 to 3.0 based on an ionic liquid. When a molar ratio (x) of a SO₂ content is less than 1.5, ion conductivity of an electrolyte decreases, and when a molar ratio (x) of a SO₂ content is greater than 3.0, vapor pressure of an electrolyte increases.

Here, the ionic liquid electrolyte includes a cation, an anion, and a substitution agent, and may be, for example, ethyl methyl imidazolium tetrachloroaluminate (EMIm-AlCl₄) or propyl methyl pyrrolidinium tetrachloroaluminate (PMPyrr-AlCl₄), which has a different structure of a cation, but the present invention is not limited thereto. The sulfur dioxide-based ionic liquid electrolyte may be represented by EMIM-AlCl₄-xSO₂ or PMPyrr-AlCl₄-xSO₂ (1.5≦x≦3.0).

Meanwhile, the ionic liquid electrolyte may be used alone as the sulfur dioxide-based electrolyte solution 1, but may be used together with a sulfur dioxide-based inorganic electrolyte. For example, as the sulfur dioxide-based inorganic electrolyte, NaGaCl₄, NaAlCl₄, Na₂CuCl₄, Na₂MnCl₄, Na₂CoCl₄, Na₂NiCl₄, Na₂ZnCl₄, Na₂PdCl₄, and the like may be used. For example, as the sulfur dioxide-based electrolyte solution 1, both an ionic liquid electrolyte and NaAlCl₄ may be used. In this case, a mixture of the sulfur dioxide-based ionic liquid electrolyte and NaAlCl₄-xSO₂ (1.5≦x≦3.0) may be used.

In addition, the case 4 may be provided to surround a configuration in which the sulfur dioxide-based electrolyte solution 1 is disposed between the positive electrode 2 and the negative electrode 3. A signal line connected to the positive electrode 2 and a signal line connected to the negative electrode 3 may be disposed at one side of the case 4. A shape or a size of the case 4 may be determined according to a field in which the sodium-sulfur dioxide secondary battery 100 is applied. A material of the case 4 may be a non-conductive material. When an insulator which surrounds the positive electrode 2 and the negative electrode 3 is provided, the case 4 may also be made of a conductive material.

As such, the sodium-sulfur dioxide secondary battery 100 according to the present invention, in which the sulfur dioxide-based ionic liquid electrolyte is used as an electrolyte solution, may be used under conditions of a temperature of 50 to 300° C. and a current of 0.001 to 1000 C. The sodium-sulfur dioxide secondary battery 100 according to the present invention has an electrode density of 0.01 to 100 mg/cm² and an amount of an injected electrolyte solution of 10 ug to 1 g. The sodium-sulfur dioxide secondary battery 100 according to the present invention may be manufactured in various battery forms, for example, in various forms such as a coin cell, a beaker cell, a pouch cell, a cylindrical cell, a prismatic cell, and the like.

In order to evaluate characteristics of the sodium-sulfur dioxide secondary battery 100 using the sulfur dioxide-based ionic liquid electrolyte according to the present invention, the sulfur dioxide-based ionic liquid electrolyte was prepared as follows.

As examples, sulfur dioxide (SO₂) gas was injected into an ionic liquid to a saturated state to prepare a sulfur dioxide-based ionic liquid electrolyte. Here, liquid electrolytes of Example 1 and Example 2 were EMIm-AlCl₄ and PMPyrr-AlCl₄, respectively.

As a comparative example, NaCl and AlCl₃ were mixed in a molar ratio of 1.1:1.0, and then sulfur dioxide (SO₂) gas was injected to prepare a sulfur dioxide-based, aluminum-based electrolyte (hereinafter, referred to as an aluminum-based electrolyte).

Sulfur dioxide-based electrolytes according to examples and a comparative example were used as an electrolyte solution to manufacture batteries according to examples and a comparative example. A positive electrode including 80 wt % of a carbon material, 10 wt % of a conductive material (ketjen black), and 10 wt % of a binder (PTFE) was manufactured so as to have a density of 2.5 mg/cm². The manufactured positive electrode, a negative electrode made of a sodium metal material, a sulfur dioxide-based electrolyte solution, and a glassy separator were used to manufacture a 2032 coin cell.

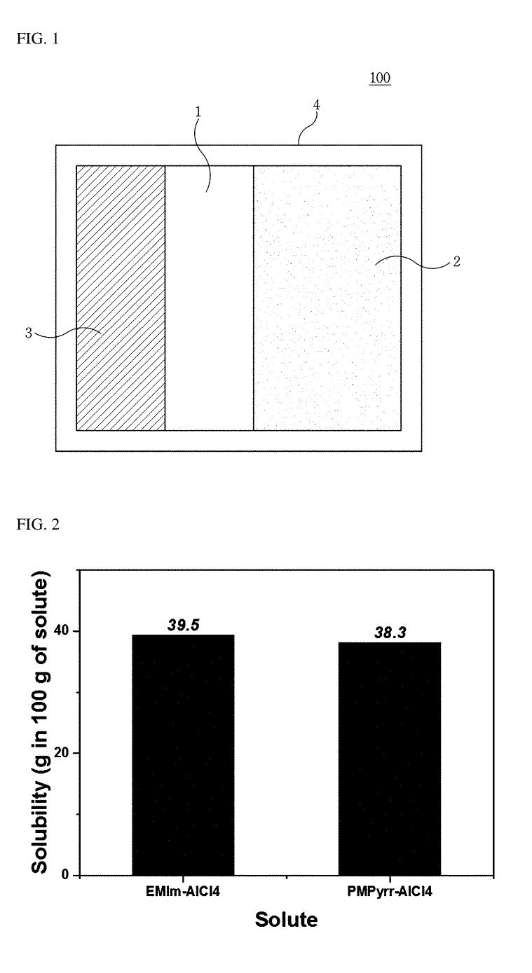

Solubilities of sulfur dioxide gas in the electrolyte solutions according to Example 1 and Example 2 were measured, the results of which are as shown in FIG. 2.

Referring to FIG. 2, it was confirmed that, in EMIM-AlCl₄-xSO₂ of Example 1 and PMPyrr-AlCl₄-xSO₂ of Example 2, 39.5 g and 38.3 g of sulfur dioxide (SO₂) were dissolved in 100 g of an ionic liquid, respectively. In this case, it can be interpreted that some of the difference in solubilities of sulfur dioxide gas is present because EMIM-AlCl₄-xSO₂ of Example 1 having relatively polarity exhibits slightly improved SO₂ solubility compared to PMPyrr-AlCl₄-xSO₂ of Example 2. This is a result of high affinity to several organic/inorganic materials, which is one of the advantages of the ionic liquid, and shows that the ionic liquid is effective for capturing sulfur dioxide gas.

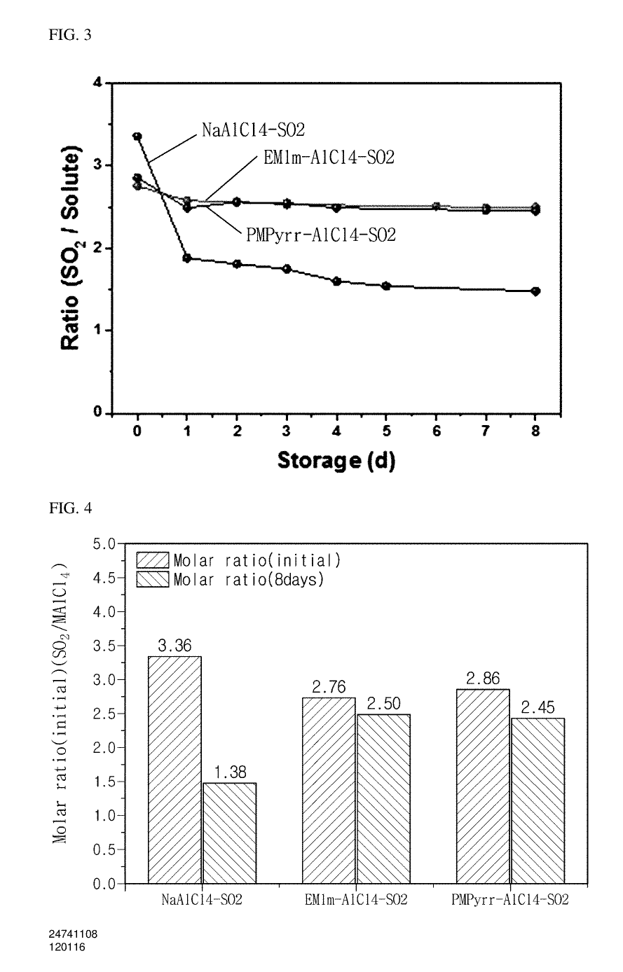

Results obtained by evaluating a change in a sulfur dioxide (SO₂) concentration based on storage time of the sodium-sulfur dioxide secondary battery according to examples and a comparative example are as shown in FIG. 3.

Referring to FIG. 3, it is shown that in the case of the comparative example, an initial sulfur dioxide concentration was rapidly changed, whereas sulfur dioxide captured in the ionic liquids according to Examples 1 and 2 was stably captured despite an increase in storage time.

This may be interpreted to be a result of non-volatility, which is one of the notable physical properties of the ionic liquid. That is, since the ionic liquid electrolyte has physical properties such as non-volatility, the ionic liquid electrolyte included in the electrolyte solution suppresses volatility of sulfur dioxide gas present in the electrolyte solution, and as a result, the sulfur dioxide gas is stably present in the electrolyte solution.

Results obtained by evaluating the storage characteristic of SO₂ in the sodium-sulfur dioxide secondary batteries according to the examples and comparative example are as shown in FIG. 4.

Referring to FIG. 4, in the electrolyte solution based on the aluminum-based electrolyte according to the comparative example, sulfur dioxide rapidly decreases after 8 days of storage, whereas in the ionic liquid-based electrolyte solutions according to Example 1 and Example 2, little sulfur dioxide is lost. That is, a content of sulfur dioxide in EMIm-AlCl₄-xSO₂ according to Example 1 is slightly decreased from 2.76 mol to 2.50 mol. Also, a content of sulfur dioxide in PMPyrr-AlCl₄-xSO₂ according to Example 2 is slightly decreased from 2.86 mol to 2.45 mol.

Based on these results, it can be seen that when being applied to a sodium-sulfur dioxide secondary battery, an ionic liquid may be used as a medium capable of being effective in stably capturing sulfur dioxide.

The embodiments disclosed in this specification and drawings are only examples to help understanding of the invention and the invention is not limited thereto. It is clear to those skilled in the art that various modifications based on the technological scope of the invention in addition to the embodiments disclosed herein can be made.

### LIST OF REFERENCE NUMERALS

1: sulfur dioxide-based electrolyte solution

2: positive electrode

3: negative electrode

4: case

100: sodium-sulfur dioxide secondary battery

1. A sodium-sulfur dioxide secondary battery, comprising:
a negative electrode made of an inorganic material containing sodium;
a positive electrode made of a carbon material; and
an electrolyte solution containing a sulfur dioxide-based ionic liquid electrolyte prepared by injecting sulfur dioxide (SO₂) gas into an ionic liquid.

2. The sodium-sulfur dioxide secondary battery according to claim 1, wherein, in the electrolyte solution, the sulfur dioxide (SO₂) gas is injected into the ionic liquid to a saturated state.

3. The sodium-sulfur dioxide secondary battery according to claim 1, wherein the ionic liquid is ethyl methyl imidazolium tetrachloroaluminate (EMIm-AlCl₄) or propyl methyl pyrrolidinium tetrachloroaluminate (PMPyrr-AlCl₄).

4. The sodium-sulfur dioxide secondary battery according to claim 1, wherein the ionic liquid electrolyte is EMIM-AlCl₄-xSO₂ or PMPyrr-AlCl₄-xSO₂ (1.5≦x≦3.0).

5. The sodium-sulfur dioxide secondary battery according to claim 1, wherein the electrolyte solution further includes a sulfur dioxide-based inorganic electrolyte.

6. The sodium-sulfur dioxide secondary battery according to claim 5, wherein the sulfur dioxide-based inorganic electrolyte is NaAlCl₄-xSO₂ (1.5≦x≦3.0).

7. A sodium-sulfur dioxide secondary battery comprising an electrolyte solution containing a sulfur dioxide-based ionic liquid electrolyte prepared by injecting sulfur dioxide (SO₂) gas into an ionic liquid.

8. An electrolyte solution for a sodium-sulfur dioxide secondary battery, the electrolyte solution comprising an electrolyte solution containing a sulfur dioxide-based ionic liquid electrolyte prepared by injecting sulfur dioxide (SO₂) gas into an ionic liquid.

9. The electrolyte solution for a sodium-sulfur dioxide secondary battery according to claim 8, wherein the sulfur dioxide (SO₂) gas is injected into the ionic liquid to a saturated state.

10. The electrolyte solution for a sodium-sulfur dioxide secondary battery according to claim 8, wherein the ionic liquid is ethyl methyl imidazolium tetrachloroaluminate (EMIm-AlCl₄) or propyl methyl pyrrolidinium tetrachloroaluminate (PMPyrr-AlCl₄).

11. The electrolyte solution for a sodium-sulfur dioxide secondary battery according to claim 8, wherein the ionic liquid electrolyte is EMIM-AlCl₄-xSO₂ or PMPyrr-AlCl₄-xSO₂ (1.5≦x≦3.0).

12. The electrolyte solution for a sodium-sulfur dioxide secondary battery according to claim 8, the electrolyte solution further comprising a sulfur dioxide-based, aluminum-based inorganic electrolyte.

13. The electrolyte solution for a sodium-sulfur dioxide secondary battery according to claim 12, wherein the sulfur dioxide-based, aluminum-based inorganic electrolyte is NaAlCl₄-xSO₂ (1.5≦x≦3.0).
